(19) United States
(12) Patent Application Publication
(10) Pub. No.: US 2009/0146066 A1
(43) Pub. Date: Jun. 11, 2009

(54) Device for superposed magnetic resonance and positron emission tomography imaging

(76) Inventors: Wolfgang Renz, Erlangen (DE); Stefan Stocker, Grossenseebach (DE)

Correspondence Address: HARNESS, DICKEY & PIERCE, P.L.C., P.O.BOX 8910, RESTON, VA, 20195, US

(21) Appl. No.: 12/314,059

(22) Filed: Dec. 3, 2008

(30) Foreign Application Priority Data
Dec. 6, 2007 (DE) 10 2007 058 688.6

(51) Int. Cl. G01T 1/166; G01V 3/14

(52) U.S. Cl. 250/363.04; 324/307

(57) ABSTRACT

A device is disclosed for superposed magnetic resonance and positron emission tomography imaging. In at least one embodiment the device includes a gradient coil and a positron emission tomography unit (PET unit). The PET unit is arranged within the gradient coil and has a first shield against radiofrequency radiation which in part surrounds the PET unit, and a second shield against radiofrequency radiation is arranged on the gradient coil. The first shield is connected to the second shield to form a shield which is at least partly closed. This makes a closed shield for the PET unit possible, which nevertheless is still easily accessible for maintenance purposes due to the two-part design of the shield.

### PRIORITY STATEMENT

The present application hereby claims priority under 35 U.S.C. §119 on German patent application number DE 10 2007 058 688.6 filed Dec. 6, 2007, the entire contents of which is hereby incorporated herein by reference.

### FIELD

Embodiments of the present invention generally relate to a device for superposed magnetic resonance and positron emission tomography imaging.

### BACKGROUND

In recent years, both magnetic resonance imaging (MRI) and positron emission tomography (PET) have found more widespread use in medical diagnostics. Whereas MRI is an imaging method for displaying structures and slice images in the interior of the body, PET allows visualization and quantification of metabolic activities in-vivo.

PET uses the particular characteristics of positron emitters and positron annihilation to determine quantitatively the function of organs or regions of cells. Corresponding radiopharmaceuticals marked with radionuclides are administered to the patient prior to the examination. In the case of decay, the radionuclides emit positrons, each of which interacts with an electron after a short distance, resulting in a so-called annihilation. Two gamma quanta are created in the process and fly apart in opposite directions (offset by 180°). The gamma quanta are detected by two PET detector modules lying opposite one another within a certain time window (coincidence measurement), as a result of which the location of the annihilation is determined to lie at a position on the connecting line between these two detector modules.

For the purposes of detection, the detector module in PET must in general cover the majority of the gantry arc-length. It is subdivided into detector elements having a side length of a few millimeters. In the case of detecting a gamma quantum, each detector element generates an event record, which specifies the time and the location of the detection, that is to say the corresponding detector element. This information is transmitted to a fast logic and compared. If two events occur within a maximum temporal interval, a gamma decay process is assumed to have occurred on the connecting line between the two associated detector elements. The PET image is reconstructed using a tomography algorithm, that is to say the so-called back projection.

In the case of MRI/PET systems, the PET detector has to be screened from the radiofrequency radiation of the radiofrequency system. In the case of known MRI/PET systems, the RF system is located on a support tube within the PET gantry, which in turn is inserted inside the gradient coil. The terms “shield” and “screen” are used synonymously. By way of example, the PET gantry can be screened by using a conventional RF shield on its inner face. In known solutions, the PET detectors each comprise their own RF shield, which results in a multiplicity of shields being required. By way of example, these shields are of a two-layered design having a slotted copper foil with a thin dielectric carrier. By way of example, the copper foils are 9 μm thick. The problem with such designs is that the gradient fields excite turbulence in the screens of the PET detectors and this leads to vibrations and heating. The vibrations mechanically strain the electronics of the PET detectors, while the heating shifts the working points of the avalanche photodiodes present in the detectors. In each case, this is dependent on the gradient activity of the PET/MRI system.

### SUMMARY

In at least one embodiment of the present invention, a combined MRI/PET system is specified which comprises an improved screen.

The device for superposed magnetic resonance and positron emission tomography imaging according to at least one embodiment comprises a gradient coil and a PET unit, with the PET unit being arranged within the gradient coil and having a first shield against radiofrequency radiation which in part surrounds the PET unit. The gradient coil has a second shield against radiofrequency radiation. The first shield and the second shield are connected to form a shield which is at least partly closed. It is a particular advantage of the described device that the PET unit is screened, preferably completely closed, from the radiofrequency radiation by the two shields. A further advantage of the two-part design of the closed shield is that service-side access to the contained PET detectors is possible without removing the shield because the first shield only partly surrounds the PET unit. In the case of only partly screening the PET unit, it is problematic that the radiofrequency fields can reach around, in particular at the ends of the PET unit, even though they are only emitted by the RF unit of the MRI/PET system lying within the PET unit. In this respect, the more comprehensive shielding significantly improves the screening properties with respect to the radiofrequency radiation.

In an advantageous refinement of at least one embodiment of the invention, a sealing element is arranged between the gradient coil and the PET unit and is designed to connect the first and the second shields. Such sealing elements are already used in known MRI systems in order to close the gaps between the components arranged radially within one another and thus to reduce the propagation of sound waves. The noise generation is thus reduced.

It is advantageous to design the sealing element as a cushion which can be evacuated. Such cushions are already used to close gaps in the case of MRI systems. They can be evacuated and thus be reduced in volume in order to be inserted into the respective gap more easily. They are inserted into the gap in the evacuated state and subsequently refilled with air or different gases or materials. This makes it possible to close the gap in an optimal manner.

Advantageously, the surface of the cushion comprises a metal layer designed such that by way of it the first shield can be connected to the second shield. By way of the metallized surface, a capacitive connection between the two shields is possible at the same time as the insertion of the cushion and so a closed shield is created. A soldering point can be used to improve the contact.

In an example embodiment, the cushion is filled with an RF absorbent material for improved screening of the RF radiation.

### BRIEF DESCRIPTION OF THE DRAWINGS

Further advantages and refinements of the invention emerge from the example embodiments described below in connection with the figures, in which

FIG. 1 shows a schematic illustration of a combined MRI/PET unit,

FIG. 2 shows a schematic illustration of an example embodiment of the invention, and

FIG. 3 shows an alternative embodiment of the invention.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

The example embodiments of the invention can preferably be used in a combined MRI/PET unit. A combined unit has the advantage that both MRI and PET data can be obtained isocentrically. This makes it possible to define precisely the examination volume within the region of interest using the data of the first modality (PET) and use this information in the further modality (magnetic resonance, for example). Although transferring the volume information of the region of interest from an external PET unit to an MRI unit is possible, there is, however, increased complexity for registering the data. In general, all data which can be obtained by magnetic resonance or any other imaging method can be determined in the region of interest selected in the PET data record. By way of example, instead of the spectroscopy data it is also possible to obtain fMRI data, diffusion maps, T1 or T2 weighted images or quantitative parameter maps by means of magnetic resonance examinations in the region of interest. It is also possible to use methods from computed tomography (for example perfusion measurement or multi-energy imaging) or x-rays. In each case, it is an advantage of the described method that by means of the PET data record the region of interest can be narrowed in a very targeted manner to a specific pathology present in a patient.

However, in addition it is also possible to display different biological characteristics in the PET data record by using a plurality of so-called tracers and thus further optimize the region of interest and the volume fixed by this, or to select a plurality of different examination volumes at once, which are then analyzed in the subsequent examinations.

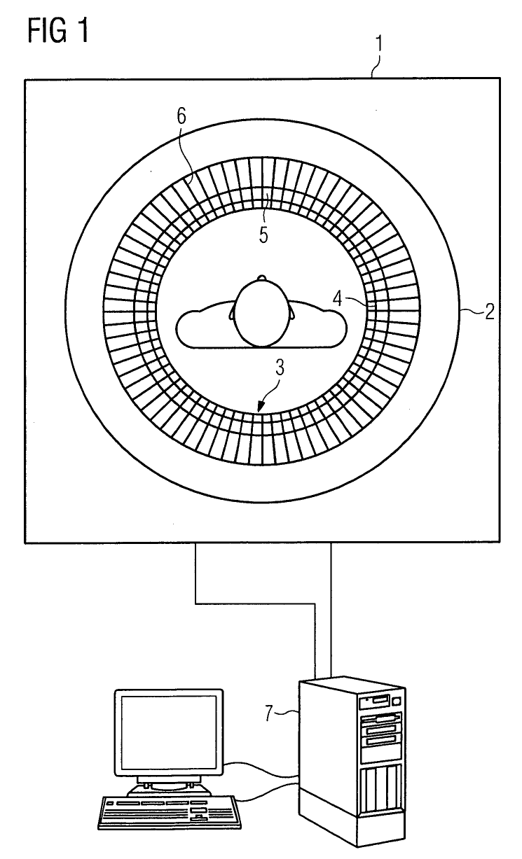

FIG. 1 shows a known device 1 for superposed MR and PET imaging. The device 1 comprises a known MRI tube 2. The MRI tube 2 defines a longitudinal direction z, which extends orthogonally with respect to the plane of the drawing of FIG. 1.

As shown in FIG. 1, a plurality of PET detection units 3, arranged in mutually opposing pairs about the longitudinal direction z, are arranged coaxially within the MRI tube 2. The PET detection units 3 preferably comprise an APD (avalanche photodiode) array 5 with an upstream array of LSO crystals 4 and an electric amplifying circuit (AMP) 6. However, the invention is not restricted to PET detection units 3 with the APD array 5 and the upstream array of LSO crystals 4; rather, it is equally possible also to use differently designed photodiodes, crystals and devices for detection.

A computer 7 carries out the image processing for superposed MR and PET imaging.

The MRI tube 2 defines a cylindrical first field of view along its longitudinal direction z. The multiplicity of PET detection units 3 define a cylindrical second field of view along the longitudinal direction z. According to an embodiment of the invention, the second field of view of the PET detection units 3 substantially corresponds to the first field of view of the MRI tube 2. This is implemented by correspondingly adapting the arrangement density of the PET detection units 3 along the longitudinal direction z.

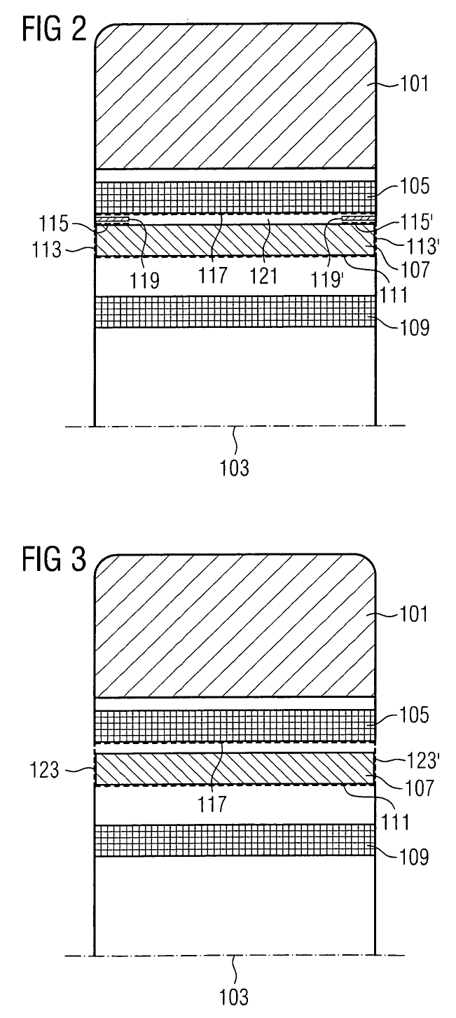

FIG. 2 schematically shows a section through the upper half of an MRI/PET system. A magnet 101 is illustrated in the outer region of the MRI/PET system and it defines a z-axis 103 by radially encircling it. A radially encircling gradient coil 105 is arranged within the magnet 101. Within the gradient coil 105, a PET gantry 107 is arranged in turn. The PET gantry 107 is at a distance from the gradient coil 105. A radiofrequency coil (body coil) 109 is arranged in a radially encircling manner inside the PET gantry 107 and at a further distance from the latter. PET detectors (not illustrated here) with electronic components are contained within the PET gantry 107. A screen 111 is provided on the inner side of the PET gantry 107 and, by way of example, is made from two plies of a 9 pm thick, slotted copper foil. The screen 111 has two sections 113 and 113′ at the end faces of the PET gantry 107. Two further sections 115 and 115′ of the screen 111 are arranged on the outer side of the PET gantry 107. A screen 117 is arranged on the inner side of the gradient coil 105. The screen 117 is capacitively coupled to the sections 115 or 115′ of the screen 111 via capacitive coupling elements 119. As a result, the screens 111 and 117 are combined to completely screen the PET gantry 107.

However, the PET gantry 107 itself is open on the outer side and not covered by a screen, so that when the PET gantry 107 is removed from the MRI/PET system, it is possible to carry out maintenance work on the PET detectors (not illustrated here) without having to open the shield 111. In particular, in this case it is not necessary to individually screen the PET detectors.

To further improve the screening of the PET detectors, it is possible, for example, to design the PET gantry 107 with improved radiofrequency damping by using suitable materials. By way of example, carbon fiber, reinforced plastics (CFRP) or a casting material provided with damping fillers can be used to this end.

The gap 121 between the gradient coil 105 and the PET gantry 107, and between the PET gantry 107 and the RF coil 109, can additionally or alternatively be sealed using a cushion which can be evacuated and which is filled with radiofrequency-absorbing foam. The cushion can be used in addition to the coupling elements 119 and 119′, or in place of coupling elements 119 and 199′. In the latter case, the cushion has a metalized surface in order to make a connection possible between the screens 111 and 117. In this case, the cushion replaces the coupling elements 119 and 119′.

FIG. 3 illustrates an alternative embodiment of the invention. The basic design is identical in principle to the one shown in FIG. 2. However, in this case the screen 117 is not coupled capacitively to the screen 111, but connected galvanically to the extensions 123 and 123′ of the screen 111. By way of example, this can be effected by means of a soldered connection. The rest of the embodiment can be effected analogously to the design shown in FIG. 2.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A device for superposed magnetic resonance and positron emission tomography imaging, comprising:
a gradient coil; and
a positron emission tomography unit (PET unit), the PET unit being arranged within the gradient coil and including a first shield against radiofrequency radiation which, in part, surrounds the PET unit, and a second shield against radiofrequency radiation being arranged on the gradient coil, the first shield being connected to the second shield to form a shield which is at least partly closed.

2. The device as claimed in claim 1, wherein the first and the second shield are directly coupled galvanically via a connecting part.

3. The device as claimed in claim 2, wherein the second shield and the connecting part are of an integral design and are connectable to the first screen via a joint.

4. The device as claimed in claim 1, wherein the first and the second shields are coupled via a capacitive element.

5. The device as claimed in claim 1, wherein a sealing element is arranged between the gradient coil and the PET unit and is designed to connect the first and the second shields.

6. The device as claimed in claim 5, wherein the sealing element is designed as a cushion which is evacuatable, wherein one surface of the cushion comprises a metal layer designed such that, by way of it, the first shield is connectable to the second shield.

7. The device as claimed in claim 5, wherein the cushion comprises a material with absorbent characteristics with regard to radiofrequency radiation.

8. The device as claimed in claim 1, wherein the PET unit comprises a support tube and PET detectors, with the support tube comprising carbon fiber reinforced plastics.

9. The device as claimed in claim 1, wherein the PET unit comprises a support tube and PET detectors, with the support tube comprising a casting material which contains a material with absorbent characteristics with regard to radiofrequency radiation.

10. The device as claimed in claim 1, wherein the screens are of multi-layered design.

11. The device as claimed in claim 6, wherein the cushion comprises a material with absorbent characteristics with regard to radiofrequency radiation.

12. The device as claimed in claim 2, wherein the PET unit comprises a support tube and PET detectors, with the support tube comprising carbon fiber reinforced plastics.

13. The device as claimed in claim 2, wherein the PET unit comprises a support tube and PET detectors, with the support tube comprising a casting material which contains a material with absorbent characteristics with regard to radiofrequency radiation.

14. The device as claimed in claim 2, wherein the screens are of multi-layered design.

15. The device as claimed in claim 3, wherein the PET unit comprises a support tube and PET detectors, with the support tube comprising carbon fiber reinforced plastics.

16. The device as claimed in claim 3, wherein the PET unit comprises a support tube and PET detectors, with the support tube comprising a casting material which contains a material with absorbent characteristics with regard to radiofrequency radiation.

17. The device as claimed in claim 3, wherein the screens are of multi-layered design.
